(19) United States
(12) Patent Application Publication
(10) Pub. No.: US 2019/0019601 A1
(43) Pub. Date: Jan. 17, 2019

(54) METHODS FOR COOLING UNDERGROUND CABLES

(71) Applicant: Naveed Aslam, Bellaire, TX (US)

(72) Inventor: Naveed Aslam, Bellaire, TX (US)

(21) Appl. No.: 15/648,851

(22) Filed: Jul. 13, 2017

(51) Int. Cl. H01B 7/42

(52) U.S. Cl. CPC H01B 7/423

(57) ABSTRACT

A method for cooling an underground pipe containing a cable for carrying electricity by feeding an inert gas stream to the underground pipe is disclosed. Cooling for the underground pipe containing the electric cable can be performed by the steps of feeding to the underground pipe the inert gas stream which will absorb heat generated by the electric cable; the warmer inert gas stream is fed to a heat exchanger where heat is dissipated and a cooler inert gas stream is recirculated to the underground pipe. The method can operate continuously while electricity is being transmitted along the cable.

### BACKGROUND OF THE INVENTION

Underground cables are a viable alternative to overhead transmission lines. Cables though have different characteristics than overhead lines that must be factored into their design, operation, maintenance and repair. Further, the cost of underground cable systems can be three to ten times that of comparable overhead lines. However, rights-of-way cost are typically much less than for overhead lines and underground lines generally have a lower perceived environmental impact making the permitting process easier less expensive compared to overhead lines.

The cost of losses in cables are generally lower than for overhead lines but reactive compensation and charging current losses must also be taken into account. In operation then the underground cable passes electricity and the flow of electrons will generate heat as there will be resistance to this flow of electricity. In an overhead electric cable network, this issue is resolved fairly readily as the heat dissipates into the air and surrounding environment.

In an underground cable environment, the generation and accumulation of heat can possibly lead to damage and melt down of the cable or encasing pipes. Therefore, it is essential for underground cables to have some sort of cooling protection. This is usually accomplished by mineral oil or other hydrocarbon products but these have shortcomings due to their flammability and limitation as to the amount of cooling they can provide. This reduces the size and capacity of underground cables, i.e., how much electricity could be passed in a given length of time.

As such, there exists a need to provide cooling to underground cables that allows for safe operation while enhancing the ability of the cable to handle a greater flow of electricity.

### SUMMARY OF THE INVENTION

The present invention relates to a method for providing cooling to an underground pipe containing a cable for carrying electricity comprising feeding an inert gas stream to the underground pipe.

In another embodiment of the invention, there is disclosed a method for providing cooling to an underground pipe containing a cable for carrying electricity comprising the steps:

a) feeding an inert gas stream to the underground pipe so that the inert gas stream absorbs heat generated by the cable for carrying electricity;

b) withdrawing the inert gas stream from the underground pipe and feeding the inert gas stream to a heat exchanger wherein the inert gas stream is cooled; and

c) feeding the cooled inert gas stream to the underground pipe.

The inert gas stream is provided to the underground pipe in a loop whereby the inert gas stream is fed into the underground pipe and contacts the warmer environment around the cable carrying the electricity, The inert gas stream absorbs heat from the warmer environment and this warmer inert gas stream is directed out of the underground pipe to a cooling station where the heat is dissipated typically to the atmosphere.

The now cooler inert gas stream is then fed back into the underground pipe providing for a continuous loop for cooling.

A device such as a pump/blower, fan, compressor or expeller/blower can be used as the motive force for the circulation of the inert gas stream by feeding the cooler inert gas stream into the underground pipe and withdrawing the warmer inert gas stream from the underground pipe after absorption of the heat.

The inert gas stream leaving the underground pipe will be warmer and will be cooled typically by exchanging heat with a heat exchanger such as an atmospheric fin type exchanger present in the cooling station. This will dissipate the heat to the surrounding air or atmosphere. Once cooled, this inert gas stream will be recirculated back into the underground pipe.

For purposes of the present invention, the inert gas is selected from the group consisting of nitrogen and argon, or mixtures thereof. The inert gas will enter the underground pipe in relatively dry condition but will absorb some moisture due to age of cable, terrain of the region, underground water tables and moisture ingress into cables.

A typical underground pipe containing an electric cable may be hundreds of miles in length. Consequently, there is a need to provide cooling along the entire length of the underground pipe. The present invention could be applied in this situation by utilizing cooling stations where there are cooling loops at periodic intervals. Depending upon the initial temperature of the underground pipe and capacity for cooling, these cooling stations could be present at varying lengths along the underground pipe to provide cooling therein.

Further depending upon the length of underground pipe to be treated and the relative temperature in the pipe, the inert gas volume can range from about 100 standard cubic foot per minute to about 1000 standard cubic foot per minute. The inert gas is typically fed to the underground pipe at temperatures of about −10° to −20° F. (−23° to −29° C.) and will be fed to the heat exchanger at temperatures of about 70° to 80° F. (21° to 26° C.).

The inert gas will typically be fed to the underground pipe at pressures in the range of 40 to 60 pounds per square inch. There will be a pressure drop after the inert gas is fed and the inert gas will be fed to the heat exchanger at pressures typically 20 pounds per square inch lower than the feed pressure.

The cooling station which will contain at least the circulations mean and heat exchanger assembly in general will be situated above the ground where the underground pipe is buried. Typically, the lines connecting the heat exchanger, circulation means and underground pipe are situated directly above the underground pipe but there could be operations where the cooling station is located at a distance from the connection with the underground pipe.

The cooling loop operation would be powered using remote power generators to provide the energy to power the circulations means, heat exchanger and cooling station in general.

Alternatively, one means for operating the cooling operation would utilize power drawn directly from the cable carrying electricity to power the circulation means, heat exchanger and cooling station. This would eliminate the need for the remote power generators.

In another embodiment, remote solar based stations can be employed to operate the blowers for the inert gas circulation system for cooling the inert gas in the underground cable networks. The use of solar power could reduce operational expenditures and will not consumer electricity being transported via the cable.

In general, the inert gas loop is continuously operating due to the continuous flow of electricity and consequential heat buildup. The flow rate and inlet temperature of the inert circulating gas feed can be adjusted depending upon peak loads for operation of the cable carrying electricity and the overall loading of these cables.

### BRIEF DESCRIPTION OF THE DRAWINGS

FIG. 1 is a cross sectional representation of an underground pipe containing cables through which electricity flows.

FIG. 2 is a cross sectional representation of an underground pipe containing cables through which electricity flows in communication with a cooling station.

FIG. 3 is a cross sectional representation of an underground pipe showing the relationship of the pipe to the soil.

### DETAILED DESCRIPTION OF THE INVENTION

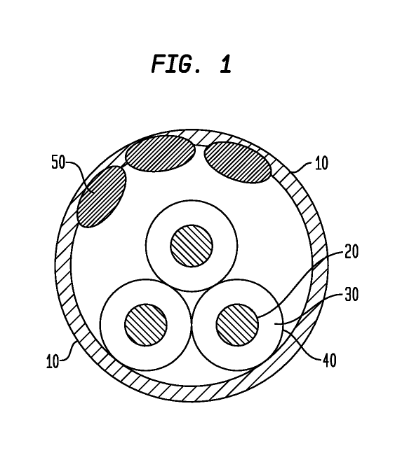

In FIG. 1 a cross section of an underground pipe 10 is shown. The underground pipe 10 contains three cables 40 which are used to carry electricity. The three cables 40 as shown are representative of cables that carry electricity and generate heat within the underground pipe 10.

Each cable 40 will have a metal core 20 which is typically copper wire and is surrounded by an insulating shell or layer 30 which is typically made of plastic.

In a typical underground pipe 10 that is designed for carrying electric cables, arc resistant coatings 50 are applied to the inside of the underground pipe thereby to provide protection against arcing which may occur that can cause problems with the effective delivery of electricity.

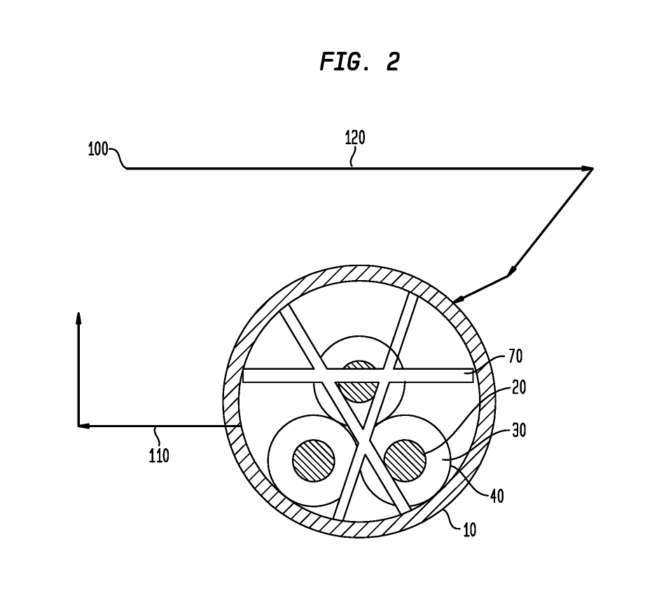

FIG. 2 is a cross section of an underground pipe 10 containing three cables 40 for carrying electricity as described above in FIG. 1. In this representation, a heat distribution grid 70 comprising metal pieces crisscrossing the underground pipe 10 are shown. These metal pieces are designed to distribute heat more evenly across the underground pipe.

The underground pipe 10 is in communication 110 with a cooling station 100 which feeds cooler inert gas through line 120 to the underground pipe 10. The cooler inert gas will absorb heat generated by the electricity bearing cables 40 and will be removed from the underground pipe 10 through line 110 by a pump (not shown) in the cooling station 100. The warmer inert gas stream that is recovered from the underground pipe 10 contacts a heat exchanger (not shown) in the cooling station 100. This heat exchanger which can be an atmospheric fin type exchanger will dissipate heat from the warmer inert gas stream which can then be recirculated by a pipe back to the underground pipe 10 as the cooler inert gas stream. The cooler inert gas stream will again absorb heat from the underground pipe 10 and be pumped back to the cooling station 100. This cycle of absorbing heat and providing cooling will operate continuously while the underground pipe 10 is carrying electricity and generating heat.

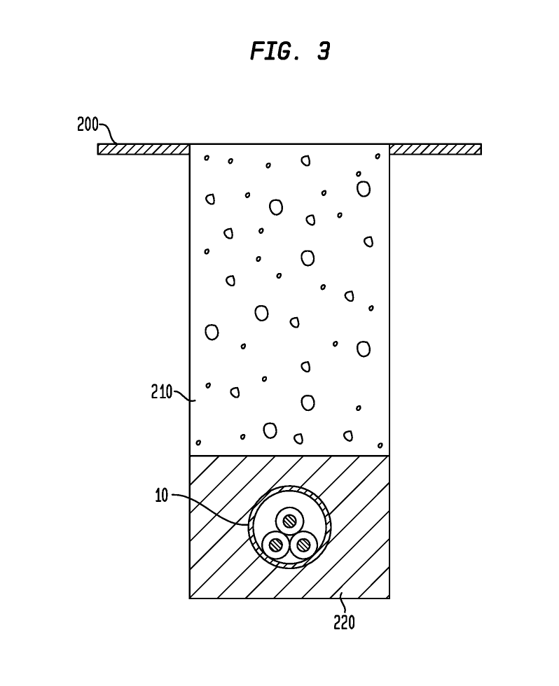

FIG. 3 is a schematic showing the relative position of the underground pipe 10 containing cables carrying electricity. Typically, at ground level 200, there is a two-foot-wide swath where the underground pipe is buried. The underground cable 10 is buried about four feed into the ground beneath a layer of native soil backfill 210 in a graded thermal backfill typically clean sand layer 220.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A method for cooling an underground pipe containing a cable for carrying electricity comprising feeding an inert gas stream to the underground pipe.

2. The method as claimed in claim 1 wherein the inert gas stream absorbs heat from the underground pipe.

3. The method as claimed in claim 1 wherein the inert gas stream is fed to the underground pipe continuously.

4. The method as claimed in claim 1 wherein a pump/blower feeds the inert gas stream to the underground pipe.

5. The method as claimed in claim 1 wherein an expeller/blower withdraws the inert gas stream from the underground pipe.

6. The method as claimed in claim 1 wherein the withdrawn inert gas stream is fed to a heat exchanger.

7. The method as claimed in claim 6 wherein the heat exchanger is present in a cooling station.

8. The method as claimed in claim 1 wherein the inert gas stream is fed from the heat exchanger to the underground pipe.

9. The method as claimed in claim 1 wherein the inert gas is selected from the group consisting of nitrogen, argon and mixtures thereof.

10. The method as claimed in claim 7 wherein a plurality of cooling stations are present along the length of an underground pipe.

11. The method as claimed in claim 1 wherein the cooling stations comprise a pump and a heat exchanger.

12. The method as claimed in claim 1 wherein the temperature of the inert gas will increase 90° after contact with the underground pipe.

13. The method as claimed in claim 1 wherein the cooling stations are powered by the cable carrying electricity.

14. The method as claimed in claim 1 wherein the cooling stations are powered by remote satellite solar electricity generating stations.

15. A method for providing cooling to an underground pipe containing a cable for carrying electricity comprising the steps:
a) feeding an inert gas stream to the underground pipe so that the inert gas stream absorbs heat generated by the cable for carrying electricity;
b) withdrawing the inert gas stream from the underground pipe and feeding the inert gas stream to a heat exchanger wherein the inert gas stream is cooled; and
c) feeding the cooled inert gas stream to the underground pipe.

16. The method as claimed in claim 15 wherein the inert gas stream is fed to the underground pipe continuously.

17. The method as claimed in claim 15 wherein a pump/blower feeds the inert gas stream to the underground pipe.

18. The method as claimed in claim 15 wherein an expeller/blower withdraws the inert gas stream from the underground pipe.

19. The method as claimed in claim 18 wherein the pump and the heat exchanger are present in a cooling station.

20. The method as claimed in claim 15 wherein the inert gas is selected from the group consisting of nitrogen, argon and mixtures thereof.

21. The method as claimed in claim 19 wherein a plurality of cooling stations are present along the length of the underground pipe.

22. The method as claimed in claim 15 wherein the cooling stations comprise a pump and a heat exchanger.

23. The method as claimed in claim 15 wherein the temperature of the inert gas will increase 90° after contact with the underground pipe.

24. The method as claimed in claim 19 wherein the cooling stations are powered by the cable carrying electricity.

25. The method as claimed in claim 15 wherein the cooling stations are powered by remote satellite solar electricity generating stations.
